(19) United States
(12) Patent Application Publication
(10) Pub. No.: US 2010/0114670 A1
(43) Pub. Date: May 6, 2010

(54) METHOD AND TOOL FOR SYSTEMATIZING INTRODUCTION OF PROCESS MODIFICATION

(75) Inventors: Val W. Workman, Pflugerville, TX (US); Byron Workman, Pflugerville, TX (US); Derick Workman, Pflugerville, TX (US); Robin Lowry, Pointe-Claire (CA); Andre Levesque, Pointe-Claire (CA); Larry Boldt, St-Charles, MO (US); Jim Holland, Eagle, ID (US)

Correspondence Address: BERESKIN AND PARR LLP/S.E.N.C.R.L., s.r.l., 40 KING STREET WEST, BOX 401, TORONTO, ON, M5H 3Y2, CA

(73) Assignee: Ryma Technology Solutions, Montreal (CA)

(21) Appl. No.: 12/262,331

(22) Filed: Oct. 31, 2008

(51) Int. Cl. G06Q 10/00

(52) U.S. Cl. 705/11; 705/7

(57) ABSTRACT

The present invention relates to a method and tool for systematizing introduction of a change to a process. The method and tool provide a virtual representation of the process, which includes at least one method having a plurality of steps. Then, the method and tool identify an input required, an output produced and corresponding control logic of at least one intervening resource involved in at least one of the steps. Finally, the method and tool evaluate, based on the input require, output produced and the control logic of the at least one intervening resource, impact of the change to the at least one intervening resource.

### FIELD

The present invention relates to introduction of modifications to processes, and more particularly to a method and tool for systematizing introduction of process modification and evaluation of impact on intervening resources.

### INTRODUCTION

The landscape of tools for organizations has greatly evolved in the past 20 years. To ensure proper functioning, most organizations define their operations by groups of processes. Each process is a series of steps or functions, for which tasks must be performed and/or documents prepared by specific function groups or individuals, to obtain specific results. By breaking up operations into processes, overall and specific functions become clearer to employees, and general efficiency and quality improved.

As many organizations are facing similar operational challenges, organizational architects study and evaluate processes to develop best practices. Nowadays, a new best practice is developed at a rate of one every week or so.

Introducing best practices to a process or multiple processes of an organization is not simple, and often results in months of delays and problems. Such delays and problems may be considered acceptable considering the long-term improvements that will be achieved, although not desirable, for some aspects or an organization. However, delays and problems resulting from modifying established processes for introducing better practices are seriously problematic for product management related processes.

One of the major issue with the modification of product management related processes, lies in the difficulty of seamlessly modifying a process, which directly and indirectly affects and potentially also modifies related processes. For those reasons, many organizations prefer opting for conservatism with their processes related to product management, and very rarely introduce modifications thereto.

There is therefore a need for methods and tools, which could facilitate the introduction of modifications and best practices to processes, and more particularly product management related processes.

### SUMMARY

The present invention relates to a method and a tool for systematizing introduction of a change to a process, and thereby facilitate the introduction of modifications and best practices to processes such as for example product management related processes.

In accordance with a first aspect, the present invention relates to a method for systematizing introduction of a change to a process. The method comprises providing a functional block diagram of the process including at least one method having a plurality of steps. The method pursues with identifying input required, output produced and corresponding control logic of at least one intervening resource involved in at least one of the steps. Then, impact of the change to the at least one intervening resource is evaluated based on the input required, the output produced and the control logic of the at least one intervening resource.

In accordance with another aspect, the present invention provides a tool for systematizing introduction of a change to a process. The tool comprises a repository, an entry unit and an evaluation unit. The repository is adapted for storing a virtual representation of the process, which includes at least one method having a plurality of steps. The entry unit is adapted for entering, for at least one step, at least one of the following for an intervening resource: an input required, an output produced, and/or control logic thereof. The evaluation unit is adapted for evaluating, based on the input required, the output produced and the control logic of the at least one intervening resource, impact of the change to the at least one intervening resource.

### DRAWINGS

In the following description, the following drawings are used to describe and exemplify the present invention, and similar references throughout denote similar parts:

FIG. 1 is a schematic representation of a group of processes and corresponding methods in accordance with aspects of the present invention;

FIG. 2 is an exemplary flowchart of a method for systematizing introduction of process change in accordance with an aspect of the present invention;

FIG. 3 is a graphical representation of an exemplary tool for measuring maturity in accordance with an aspect of the present invention;

FIG. 4 is a graphical representation of a tool for identifying modifications required in training;

FIG. 5 is an exemplary graphical representation of a communication package in accordance with an aspect of the present invention;

FIG. 6 is a schematic block diagram of a tool for systematizing introduction of process change in accordance with another aspect of the present invention;

FIG. 7 is a schematic representation of exemplary information stored in a repository;

FIG. 8 is a schematic representation of exemplary direct and indirect intervening resources;

FIG. 9 is a schematic representation of an exemplary implementation of the present invention for product management; and

FIG. 10 is a schematic representation of an Enhanced Function Block Diagram (EFBD) in accordance with one aspect of the present invention.

### DESCRIPTION OF VARIOUS EMBODIMENTS

Introduction of improvements to processes, and more particularly to product management related processes, is a difficult task. Multiple aspects must be considered, and if the analysis is not performed adequately, the introduction of improvements may turn into catastrophic situations.

Various aspects have to be considered prior to introducing a modification or improvement. First, data must be collected on practices applicable to the process to be improved. Then, each of the identified best practices is studied and validated, and a rationale identified. Then comes the moment to decide whether a best practice should be implemented. In the event that a favorable decision is made, organizational architects determine how and when to implement the selected best practice, taking under consideration current tools, training, etc.

These various steps may take several weeks, even months to realize. Furthermore, as there are no method or tool to systematize the introduction of modifications, changes or best practices to current processes, assistance from consultants specializing in organizational architecture must sometimes be sought. The advice provided by such consultants is directly dependent of their personal experience, and may vary greatly from one consultant to the next.

The present invention thus provides a method and a tool for systematizing introduction of process modification. Furthermore, the present invention provides a systematized method of introducing best practices to product management related processes.

Throughout the present application, organization is used and is meant to include profit and non-profit organizations, companies, multinationals, etc.

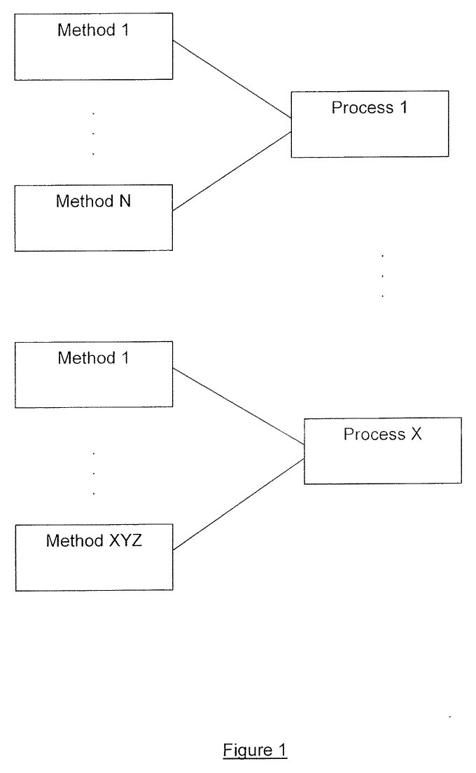

Reference is now made to FIG. 1, which depicts a schematic representation of a group of processes and corresponding methods. Typically, an organization defines its functioning with the help of processes. An organization may rely on one or multiple processes, depending on the complexity and the scope of aspects addressed by the organization. Each process may in turn be composed of one or multiple methods. Each method corresponds to a series of steps realized in the context of the method. The steps may be organized in such a manner as to correspond to a sequence of events undertaken to obtain a desired result. The steps may also be performed partially or entirely in series, and may be organized in such a manner as to be divided in function of responsible entity. The granularity in steps and methods is dependent on the desire of the organization to organize and control at a higher or lower level the operations of entities such as employees, sections, departments and functional groups. FIG. 1 is thus an exemplary representation of methods combined to form processes, and should not be interpreted as representing the processes of the present invention. The methods referred to in the present application may include few or several steps, performed sequentially and/or concurrently. The present invention is not limited to specific processes, but is rather applicable to all sorts of processes, and greatly advantageous in introducing changes for highly demanding processes such as product management, where delays and quality issues caused by introduction of changes are not acceptable.

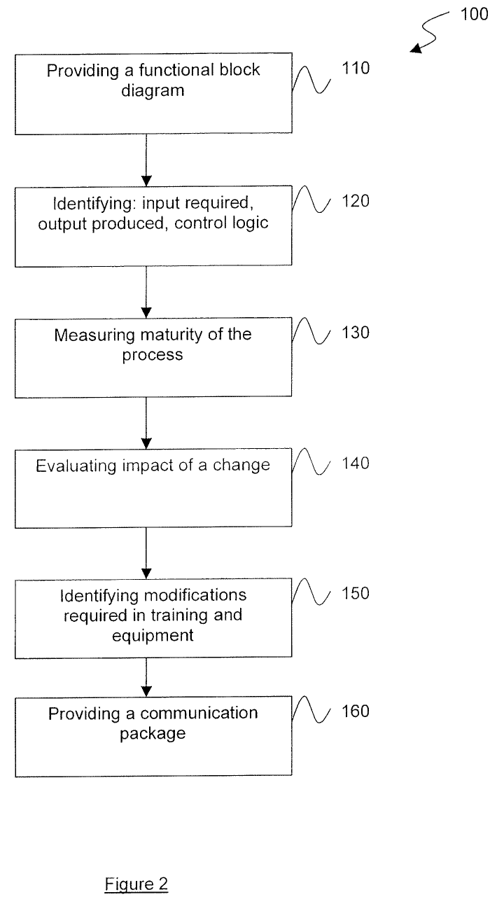

Turning now to FIG. 2, there is shown a flowchart of a method 100 for systematizing introduction of one or several process changes in accordance with an aspect of the present invention. The method starts with providing in 110 a functional block diagram of a process. The process includes at least one method. The process may be represented as a functional block diagram, or in any other form known in the art for describing and representing processes. In the context of the present invention, the process or subcomponent thereof, such as the method of steps of the method may be provided with corresponding one or several business objectives. The advantage of linking business objectives to the process or components thereof will be explained further.

The method continues in 120 with identifying information required for at least one step of the process. The information may consist of one or multiple of the following information: input required, output produced, and/or control logic of at least one intervening resource. The control logic refers to one or a set of requirements for performing the corresponding step.

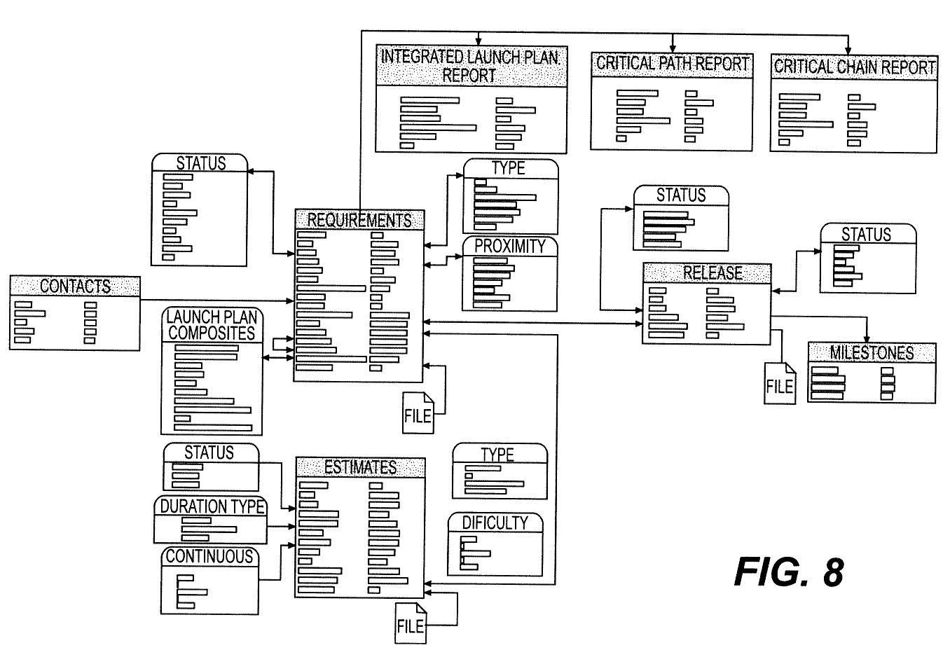

Intervening resource in the context of the present invention refers to any type of resource required in performing a step of the method. FIG. 8 depicts exemplary intervening resources, and relations there between. Examples of intervening resources include a specific tool with a defined functionality of particular revision, any physical tool required to perform the expected output to be produced, a type of network required, an employee with predefined skill sets or having a particular job description, identification of a consultant or consulting firm, identification of a team, section, department, functional division, organization, etc. Thus the intervening resource refers to any possible type of resource required to perform the step, either physical, software, functional or human.

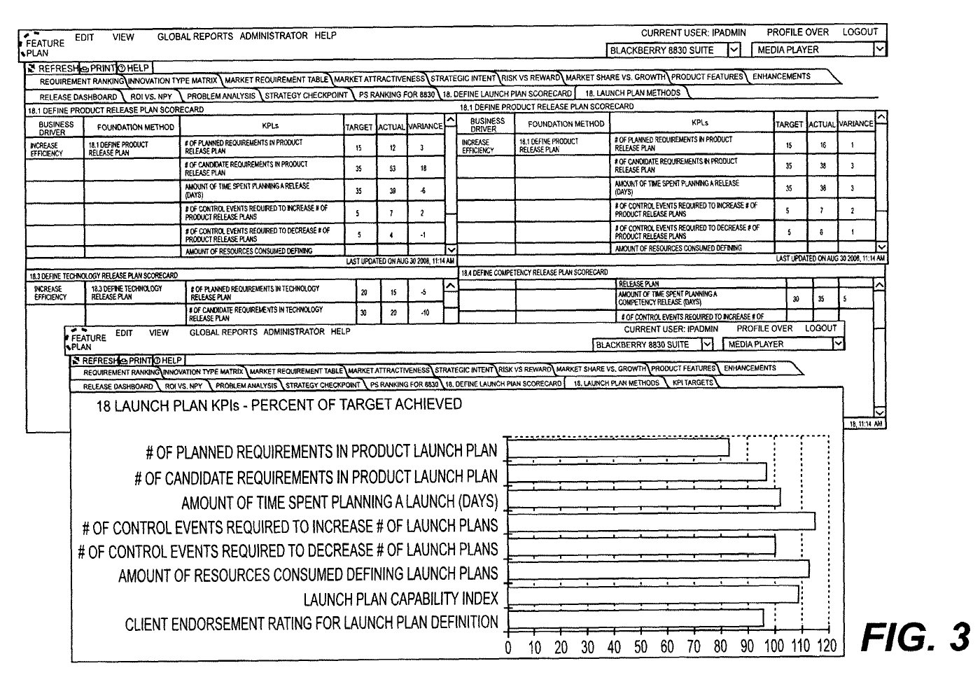

The method continues with measuring 130 maturity of the process. Measuring maturity of the process may be an optional function performed in the context of the present invention. However, measuring the maturity offers several advantages. By introducing an organized and systematic way of measuring maturity of the process, it is possible to use the information subsequently to determine whether the process and its implementation have reached a sufficient level of maturity prior to introducing further changes. The maturity can be measured at the process level, at the method level or at the step level. Such granularity thus allows to identify problematic areas, and allow mature part of the process, which are ready to benefit from the introduction of a better practice. FIG. 3 depicts an exemplary tool that can be used to measure the maturity of the process/method/step.

The method continues with evaluating impact 140 of the change on the process. The impact is evaluated by verifying whether the intervening resources of the various steps of the method are adapted to handle the change. For example, if the change requires an adapted tool or an employee having a particular skill sets, the evaluation of the impact will verify whether all steps of the process already have access to the adapted tool, and/or the employees performing these steps have the required skill sets. By validating at the various levels, i.e. process/method/step that the required resources are available or not, it is possible to identify the impact at the process level of the introduction of the change on the intervening resources. It should of course be understood that introduction of change in a process will not necessarily affect all resources involved in the process, but rather affect specific resources involved for particular steps. Thus the evaluating must take under consideration the fact that impact should preferably be considered only for intervening resources of the steps to be modified. However, it could alternately be interesting, so as to validate whether the introduction of the change could be adversely affect indirectly other resources of the process, to perform the evaluation for all resources participating to the process, whether intervening directly or indirectly. An example of such an indirect intervening resource may include a technical support group responsible of technical support of computers. Thus if the change to be introduced includes using a new software, the addition of the new software will result in indirectly affecting the technical support groups which will need to be trained to support the new software. Thus the present invention is adapted to account for both direct and indirect intervening resources.

The evaluating 140 of the impact may be performed by considering the effect and/or requirement based one or several of the following: the input required, the output produced, the control logic, corresponding business objective, maturity level, etc, taken solely or in combination. The input required may correspond to the type of document, software, unit, piece, that is expected by the step. The output produced may for example refer to a document, a unit, a component, resulting from performing the step. The control logic in turn refers to one or several of the following: capability of equipment, version of a software, bandwidth of a network, size of memory, skills of an employee, training of one or several employees.

Upon receipt of the input required, the step may be performed in accordance with the corresponding control logic to produce the output. Upon modification of the input, some adjustment must be made to the control logic to assure the same output produced. Alternately, the change could consist of receiving the same input required, but modifying the output produced, which also require performing some modifications to the control logic. It could also be possible, in the context of the present invention to modify both the input required and output produced of a step simultaneously. It could also be possible, in the context of reorganizations, to consider maintaining the input required, the output produced, but to replace the individuals performing the corresponding step. Thus as can be appreciated, the present invention is flexible, and is adapted to systematize introduction of various types of changes to processes such as: organizational, equipment, human skill sets, etc.

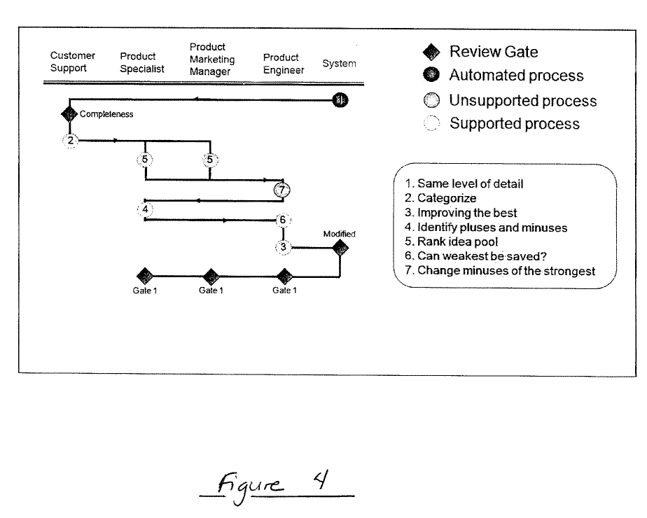

Once the evaluation of the impact 140 is completed, it is possible to identify modifications required to intervening resources of the process to support and implement the change. Such modifications could for example include new or adapted training, buying or changing current tool and/or equipment. Other types of modifications could include impact on indirect intervening resources, and required modifications to be performed for proper support of the modification by indirectly intervening resources. By evaluating impact of the change on all intervening resources, it is possible to identify global impact of change on both direct and indirect intervening resources, and thus identify the modifications required for both direct and indirect intervening resources to support the introduction of the change. FIG. 4 provides an exemplary tool for identifying modifications in training.

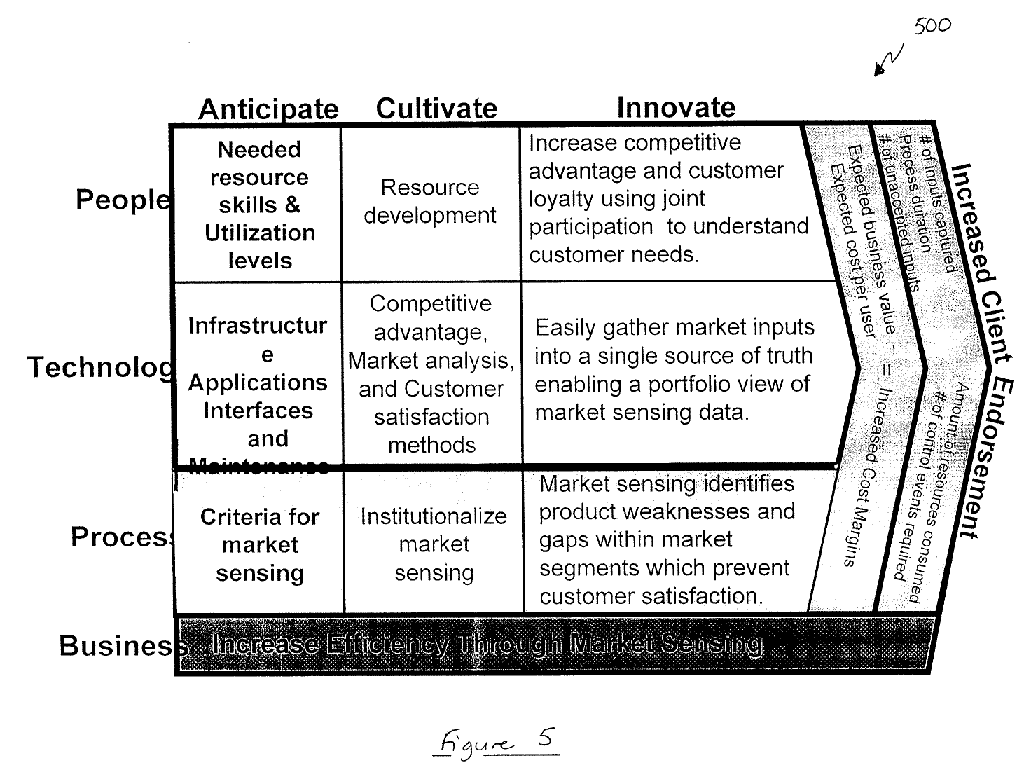

Finally, the method proceeds with providing a communication package 160. As known to persons skilled in the art of processes, proper communication of introduction of a change and corresponding impact on all intervening resources is essential to smooth implementation. Too often, although introduction of a change is welcomed and recognized as required, its introduction results in a period of uncertainty and instability, and sometimes in general resentment towards introduction of changes in processes. It is thus important to properly evaluate impact of the change on both the direct and indirect intervening resources, and proper communication to all intervening resources. Reference is now made to FIG. 5, which provides an exemplary graphical representation of a communication package 500. The depicted communication package is presented in the form of a table with rows, columns, an underlying business object, and expected results following the introduction of the change represented as arrows on the right-hand portion of the table. The rows correspond to the following aspects: people, technology and process. The columns refer from left to right to a phase of anticipating, a phase of cultivating and a phase of innovating. These three phases describe aspects, which are important for employees to understand and accept the introduction of a change. Without understanding the “why” and “how” changes are implemented, employees become demotivated, and often negatively impact the introduction of the change. Thus by communicating the “why” and “how” in a systematic manner, the introduction of changes becomes part of the regular operations of the company. The bottom of the table corresponds to the business objective of the process, or if a greater granularity is desired, to the method or particular step. Thus, in this example, the communication package addresses in one single communication the reasons for the change, the expected results, and the alignment with business objective(s).

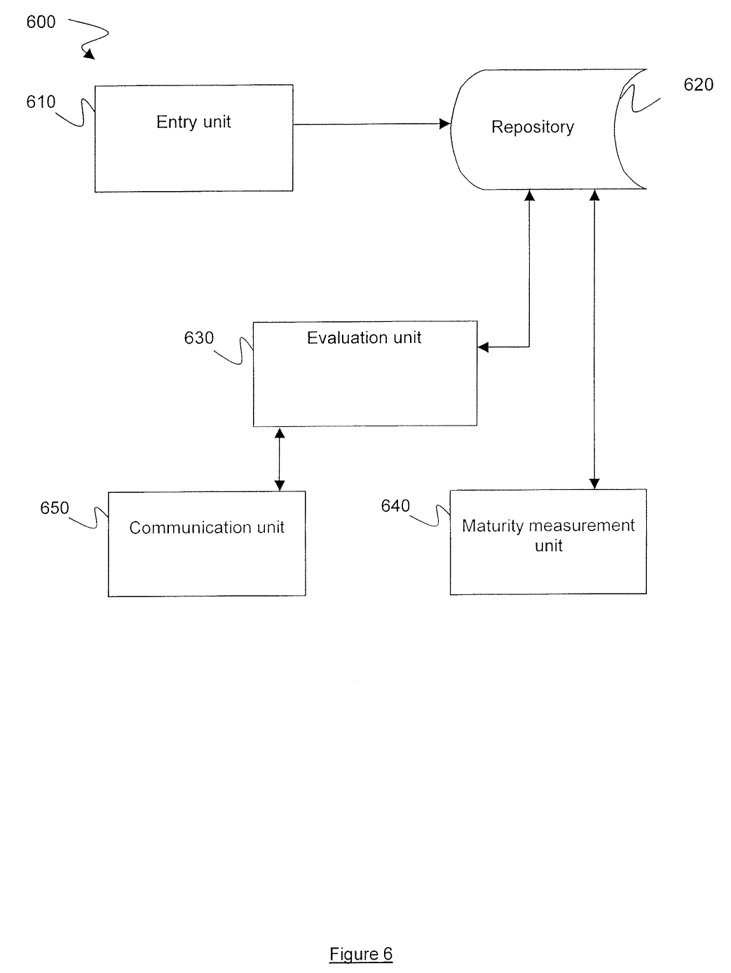

Reference is now made to FIG. 6, which represents a schematic block diagram of a tool 600 for systematizing introduction of process change in accordance with another aspect of the present invention. The tool comprises an entry unit 610, a repository 620, an evaluation unit 630, a maturity measurement unit 640 and a communication unit 650. The entry unit 610, evaluation unit 630, maturity measurement unit 640 and communication unit 650 may be implemented as software or hardware.

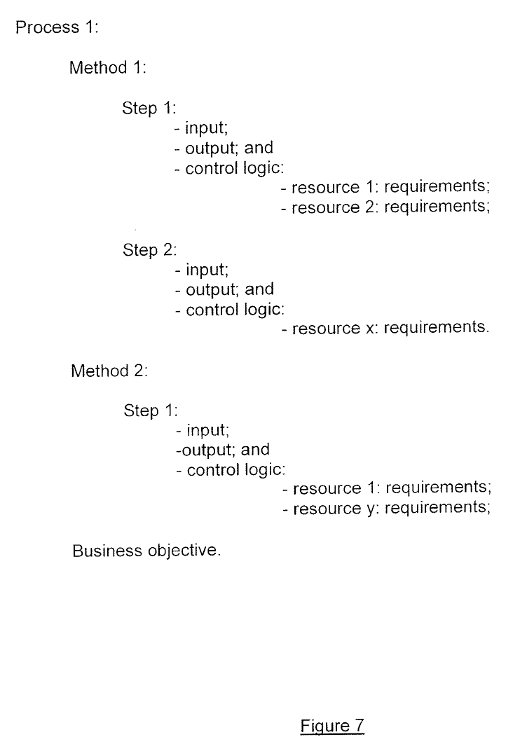

The entry unit 610 is adapted for entering, if not already provided, information on the at least one step such as the input required, output produced, control logic, on a per intervening resource basis. The information is stored in the repository 620. An example of the information stored is shown on FIG. 7, which is concurrently referred to.

FIG. 7 is a schematic virtual representation of exemplary process and corresponding information stored in a repository. The information is stored in such a manner that it is possible to link the method to the information on the step, the step to the method and the method to the process. The information entered either through the entry unit 610, or already available in the repository 620 includes input required, output expected, and corresponding control logic for each intervening resources. It is possible that some of the intervening resources be involved in more than one step, in more than one method, and in more than one process. By consistently identifying the intervening resources, it becomes thus possible to grasp a better overview of the impact of the change on the overall organization, either directly or indirectly. The repository 620 is further adapted for storing information on corresponding business objectives, and measured maturity.

The entry unit 610 is thus adapted for entering, information on both the currently implemented process as implemented in the organization, and the desired modified process, which includes the desired change. The information on the currently implemented process may consist or a virtual representation of the currently implemented process. Once the information on the currently implemented process is stored in the repository 620, it is not necessary to enter it again. Alternately, the information on the currently implemented process can be entered by various methods such as importing the information from another database or system, which is compatible with the repository 620. The information on the process including the desired change may be entered via the entry unit 610 in many different ways. For example, the information may be entered at a process, method or step level only, or at multiple levels concurrently.

The evaluation unit 630 then evaluates, based on the information stored in the repository, impact of the change to at least one of the intervening resources. The evaluation unit 630 is adapted for evaluating impact of the change to all types of intervening resources simultaneously, or to different types of intervening resources independently. For example, in the case of equipment, the evaluation unit 630 can determine, based on the change desired, the impact of that change of the equipment for the method and/or process in which the change is implemented. Additionally, the evaluation unit 630 is further adapted for evaluating the impact of the change on the other method/processes which are related to the process in which the change is to be implemented. Thus, in the case of equipment for a process related to product management, the evaluation unit 630 identifies the impact of the change to the equipment currently used by the method/process, and then determines impact of the change to a technical support group, responsible for buying, maintaining, and managing a pool of equipment for the organization. Thus, an indirect impact of the change to the process could for example include: upgrading the computers used by the process, reallocating more equipment to the process, requiring new equipment, requiring new software or more licenses of a software, recycling equipment unused in other areas for the individuals involved in the process where the change is to be implemented, etc.

Another example of the type of evaluation performed by the evaluation unit 630 includes evaluating training needs for the individuals involved in the realization of the process in which the change is to be implemented. Too often, organizations underestimate the impact of a change to a process, and one such aspect is on the individuals involved in the process. For example, if new software is to be implemented for supporting the change, verification has to be made to determine whether the individuals currently involved in the process have the required skills to use this new software. If the new software requires skills sets that were not necessary previously and were not identified as a requirement for those intervening resources (individuals using the software for effectuating the step(s) of the method), the introduction of the change and the new software to support the change, may indirectly result in a loss of productivity by the intervening resources who will need to use the new software. Thus the evaluation unit 630 identifies the gap between the current skills set of the individuals performing the step(s) of the process with the current software and the skills sets required for using the new software. By systematizing the evaluation of the impact of the change on intervening resources, it is possible to globally assess the full scope of a change to be implemented, and handle the change globally, by considering and simultaneously addressing the impact on all the resources intervening directly or indirectly in the realization of the process.

For identifying the impact of the change, the evaluation unit 630 compares the information stored in the repository for the input required, output produced and control logic of the current process and/or method, with the input required, output produced and control logic for each step of the modified process and/or method and/or step. By systematically comparing the input required, output produced and control logic for each step of the process, it is possible to evaluate the full impact of the change, and not simply the difference in the steps of the method/process.

In accordance with another aspect of the present invention, the evaluation unit 630 is adapted for comparing the current method and the modified method at a higher level, i.e. at the method level, instead of the step level. Such an evaluation may be interesting to executives of the organization in determining the impact of the proposed change to the currently implemented process. By comparing at a higher level, i.e. at the process level, it is possible to quickly identify existing gaps for the intervening resources at the process level, without getting through the details at the step level.

In another aspect of the present invention, the evaluation unit 630 is further adapted for taking into consideration in the identifying of the impact of the change to the currently implemented process, the maturity of the currently implemented process. For example, when a change has been recently introduced to the currently implemented process, it is greatly valuable to determine whether the currently implemented process has already successfully integrated the recently introduced change, prior to proceeding with the introduction of a new change. Thus, by considering the maturity of the currently implemented process, it is possible to determine that certain steps of the method, or certain methods of the process, are still adapting to the previously introduced change, and thus for those steps/methods, it is possible for the evaluation unit to identify a gap that considers both the previously introduced change and the new change to be introduced. For gathering information on the maturity of the currently implemented process, the maturity measurement unit 640 collects information from the various intervening resources on a degree of maturity of the currently implemented process, method of steps thereof. An example of such a maturity survey is provided on FIG. 3.

The evaluation unit 630 may also take under consideration, upon identifying the gap between the currently implemented process and the modified process on the intervening resources, the alignment of the change with the business objective for the method and or process to be modified. Thus the evaluation unit 630 may for example provide an indication that the change is not aligned with current business objective or would hinder the achievement of the business objective.

The evaluation unit 630 further communicates with the communication unit 650, which is adapted to receive the impact of the change as evaluated by the evaluation unit 630, and generating there from a communication package. The communication package may consist on formatting and organizing the information provided by the evaluation unit so as to describe the impact of the change on the process and or method. Alternately, the communication unit 650 may generate from the information generated by the evaluation unit 630, a communication package for the employees impacted by the change, as shown on FIG. 5. The communication unit 650 may further generate any type of communication package which may assist in either the decision as to whether the change should be implemented, or in communicating the impact of the change to all involved intervening parties, either directly or indirectly.

The tool 600 and its components, the entry unit 610, evaluation unit 630, maturity measurement unit 640 and communication unit 650 may be provided as a modular software, which allows clients to select which units are of most interest to their organization. Alternately, the tool 600 and its components could be provided as an embedded system. The tool 600, or certain units thereof, could be implemented on a network, so as to allow employees of the organization to maintain their corresponding information in the repository 620.

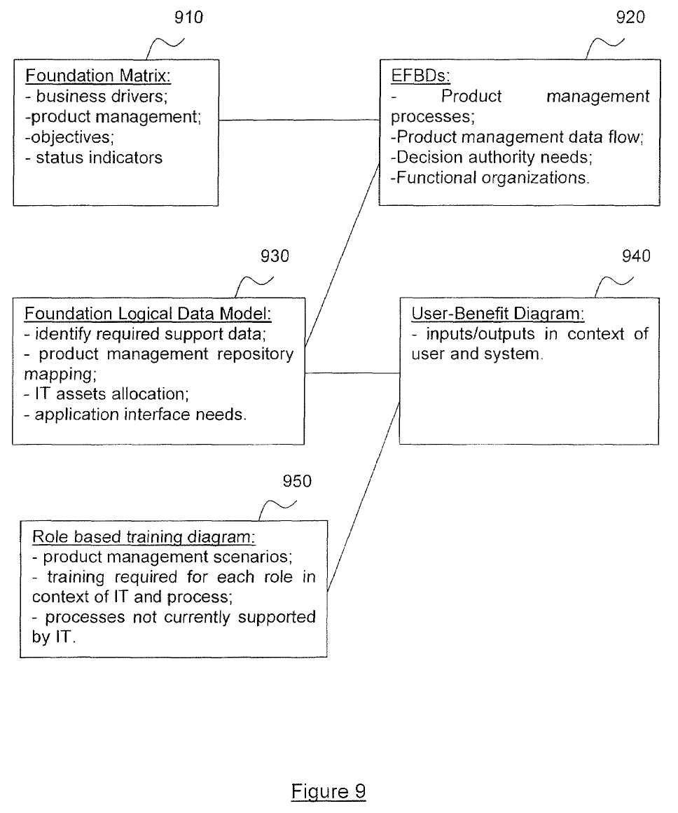

Reference is now made to FIG. 9, which depicts a schematic representation of an exemplary implementation for product management. In this particular embodiment, an overall new product management process has been put in place. This new product management process takes into consideration complimentary aspects (business drivers, objectives, status indicators, required resources, etc.), which are not usually incorporated within an overall product management process. Typically, in prior art processes, a product management process defines and describes steps and intervening parties for performing the steps to successfully produce the expected product. In the context of the present invention, the prior art product management process becomes one constituent of an integrated product management process, which includes intervening resources and control logic thereof. To clearly represent the various intervening resources and control logic, the product management of FIG. 9 is divided into 5 sub-categories, where each sub-category corresponds to a specific aspect, and the interrelations there between.

The first subcategory is titled “Foundation matrix” 910. The “Foundation Matrix” maintains the focus of a process by providing an overview of the purpose and future of a process, along with a scope definition of what needs to be communicated. By following the laws of encapsulation it is possible to create “bite-sized” modules of the overall product management, thereby facilitating change adoption. The “Foundation matrix” aligns aspects relates to resources (people and technology), with process and business objectives (business drivers and status indicators) through steps of anticipating market problems, cultivating business opportunities and innovating product solutions. FIG. 5 provides a graphical representation of a “Foundation Matrix's” communication package.

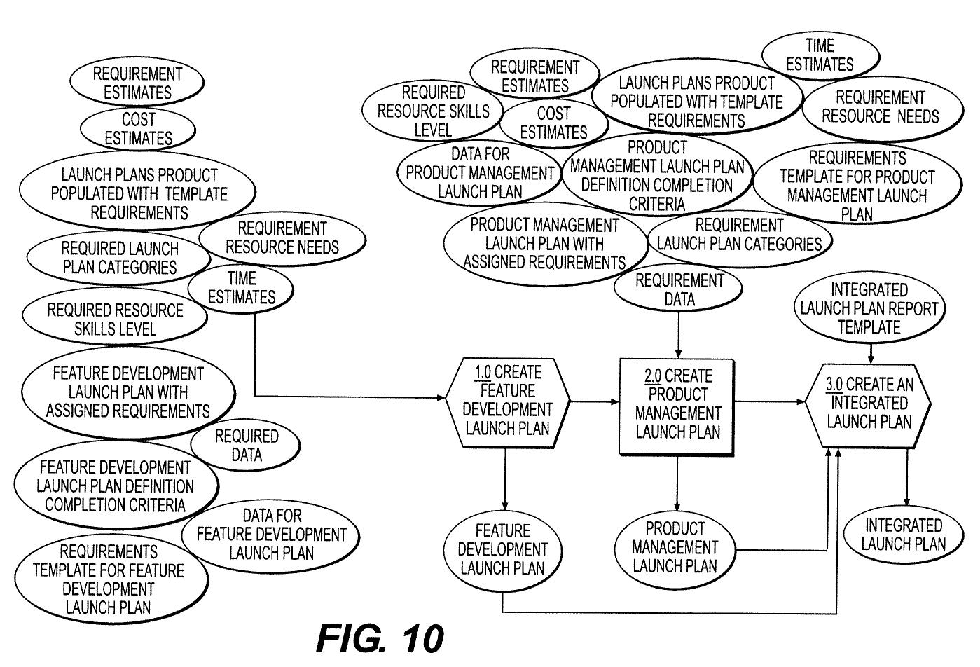

The “Foundation Matrix” 910 is then connected to an Enhanced Function Block Diagram (EFBD) sub-category 920. The EFBD 920 consists of a functional block diagram, such as concurrently shown on FIG. 10, in which a definition of information required and information produced is provided. The EFBD 920 also includes control logic for the process. It is the combination of the control logic and the definition of information required and produced which enhance the functional block diagram into the EFBD 920. In addition to the enhancement discussed, the EFBD 920 documents the specific process being implemented. By enhancing prior art function block diagram as herein described, it is possible to enable quick change impact analysis, increase process maintainability while lowering overall cost of ownership. Such a visual diagram further helps gain rapid consensus for process standardization and lower new-process ramp-up time. By using the EFBD, organization can validate data-flow and process control logic prior to implementation and thereby reduce rework costs.

In addition to being interconnected with the “Foundation Matrix” 910, the EFBD 920 is further interconnected with a “Foundation Logical Data Model (FLDM)” 930. The FLDM 930 integrates product management activities with other activities found within the company, thereby breaking down process and informational silos. An example of a graphical representation of the FLDM is concurrently found on FIG. 8. The FLDM 930 allows amongst other things to leverage existing information technology investments from clearly specified data needs. It further provides a mapping of relationships between entity attributes rather than just entities. It may further contain industry standard values for pull-down menus and relationship definitions including mathematical expressions for computed information. It may further define data types, logical database entities including dashboard, scorecards, and reports along with statistical entities used to capture persistent data. The FLDM 930 may thus include any combination of the following: required support data, product management repository mapping, IT assets allocation and application interface needs.

The FLDM 930 is in turn interconnected to a user-benefit diagram 940. The user-benefit diagram 940 defines the inputs/outputs in context of user and system (required resources). The user-benefit diagram 940 is further connected to a role based training diagram 950, of which an aspect thereof is shown concurrently as an example on FIG. 4. The role based training diagram 950 may cover any of the following aspects: product management scenarios, training required for each role in context of information technology and process, and identification of processes not currently supported by information technology.

By implementing the present invention in these 5 sub-categories, namely the “Foundation Matrix” 910, the EFBDs 920, the FLDM 930, the user-benefit diagram 940 and the role based training diagram 950, it is possible to systematize introduction of change to processes by considering the intervening resources and the corresponding control logic in a visually eloquent, and in a manageable fashion.

The present invention has been described by way of preferred embodiments. It should be clear to those skilled in the art that the described preferred embodiments are for exemplary purposes only, and should not be interpreted to limit the scope of the present invention. The method and tool as described in the description of preferred embodiments can be modified without departing from the scope of the present invention. The scope of the present invention should be defined by reference to the appended claims, which clearly delimit the protection sought.

1. A method for systematizing introduction of a change to a process, the method comprising:
providing a virtual representation of the process, the process including at least one method having a plurality of steps;
identifying input required, output produced and corresponding control logic of at least one intervening resource involved in at least one of the steps;
evaluating, based on the input required, the output produced and the control logic of the at least one intervening resource, impact of the change to the at least one intervening resource.

2. The method of claim 1, wherein the at least one intervening resource is one of the following: a tool, software, a computer, a network, an employee, a consultant, a section or a department of an organization.

3. The method of claim 1, wherein the process is a product management process.

4. The method of claim 2, wherein the control logic includes one or several of the following: capability of equipment, version of a software, bandwidth of a network, size of memory, skills of an employee, training of one or several employees.

5. The method of claim 1, wherein:
the functional block diagram further comprises at least one corresponding business objective;
the method further comprising:
identifying modifications required to the at least one intervening resource based on the evaluated impact and the business objective; and
providing a communication package describing the change and the defined modifications in relation to the at least one intervening resource and the business objective.

6. The method of claim 1, wherein the control logic comprises a set of requirements for performing the corresponding step.

7. The method of claim 1, further comprising:
measuring a maturity of the process,; and
wherein the evaluating is further based on the measured maturity.

8. A tool for systematizing introduction of a change to a process, the tool comprising:
a repository for storing a virtual representation of the process, the process including at least one method having a plurality of steps;
an entry unit for entering for at least one step, at least one of the following for an intervening resource: an input required, an output produced, control logic thereof;
an evaluation unit for evaluating based on the input required, the output produced and the control logic of the at least one intervening resource, impact of the change to the at least one intervening resource.

8. The tool of claim 7, wherein the at least one intervening resource is one of the following: a tool, software, a computer, a network, an employee, a consultant, a section or a department of an organization.

9. The tool of claim 7, wherein the process is a product management process.

10. The tool of claim 8, wherein the control logic includes one or several of the following: capability of equipment, version of a software, bandwidth of a network, size of memory, skills of an employee, training of one or several employees.

11. The tool of claim 7, wherein:
the repository further stores at least one business objective related to the process; and
the evaluation unit is further adapted to evaluate impact of the change to the at least one intervening resource further based on the at least one business objective.

12. The tool of claim 11, further comprising a communication unit for preparing a communication package describing the change and the defined modifications in relation to the at least one intervening resource and the business objective.

13. The tool of claim 7, wherein the control logic comprises a set of requirements for performing the corresponding step.

14. The tool of claim 7, further comprising:
a maturity measurement unit for measuring a relative maturity of the process; and wherein:
the evaluation unit is further adapted to evaluate impact of the change to the at least one intervening resource based on the relative maturity.
